(19) United States
(12) Patent Application Publication
(10) Pub. No.: US 2007/0244791 A1
(43) Pub. Date: Oct. 18, 2007

(54) System and method for linked execution of securities transactions

(75) Inventors: Magdalena Feldhoffer, Bad Soden am Taunus (DE); Christian Haffner, Frankfurt am Main (DE)

Correspondence Address: NIXON PEABODY, LLP, 401 9TH STREET, NW, SUITE 900, WASHINGTON, DC, 20004-2128, US

(73) Assignee: DEUTSCHE BORSE AG, Frankfurt/Main (DE)

(21) Appl. No.: 11/402,253

(22) Filed: Apr. 12, 2006

(51) Int. Cl. G06Q 40/00

(52) U.S. Cl. 705/37

(57) ABSTRACT

The present invention relates to an electronic trading system and a method for automatically performing an execution of an order from a market participant against a quote of a market maker. According to the present invention, an order from a market participant is executed against the matching quote of a market maker only, if a corresponding hedge transaction for mitigating the market maker's execution risk has been generated and successfully executed. Thereby the initial order and the hedge transaction preferably relate to different markets, such that the invention provides a conditional link between trades performed in these markets.

### BACKGROUND OF THE INVENTION

1. Field Of The Invention

The present invention generally relates to electronic trading systems for financial products. More specifically, the present invention relates to the trading of two orders for different financial products and/or in different markets such that either both orders or none is executed.

2. Background Art

In recent years trading of financial securities has increased considerably. In this connection the demand for new financial instruments has emerged. Especially, the derivative markets have shown a tremendous growth. Electronic trading systems have become state of the art for trading financial instruments, such as securities and derivatives, as they provide several advantages compared to manual methods of trading. Such advantages include, for instance, increased matching speed and accuracy, reduced labor costs, and the ability to quickly disseminate market information.

In view of these advantages, electronic trading systems are going to replace traditional floor trading at the stock exchange. Typically, electronic trading systems have a central server associated with a plurality of remote terminals through which trades can be made.

A conventional electronic trading system employed at an electronic stock exchange is capable of matching a plurality of requests for a product against a plurality of bids for the same product. An average price level of the executed trade is determined and displayed, so as to reflect the current market value of the product. The electronic trading system known in the art is moreover capable of automatically clearing the executed trade.

Due to the wide range of financial instruments and their complexity, the situation may occur, wherein the market liquidity is not sufficient for a market participant to always find a matching order from another market participant trading the same financial product.

This situation has led to the presence of a specific kind of traders called market makers. Market makers are specialized in particular financial instruments and offer these products to other market participants for buying and selling.

The duty of a market maker is to provide liquidity in the products he specializes in for the market. Market makers are responsible for providing quotations either continuously or upon request in all of their assigned products, which is usually supported by automatic quotation and execution.

Thus, the presence of a market maker supports continuous trading and improves liquidity in the respective market.

The compensation for the services of a market maker corresponds to the spread between bid and ask prices of executed transactions.

A market maker may change quotes he provides at every time. It is a duty of a market maker to buy, respectively sell at these quotes on demand of an authorized market participant.

However, the market maker is not willing to take over risks from positions held in his products and is carrying out one or more hedge transactions in related instruments and/or markets to offset these risks. This implies that the market maker has to carry out more than one transaction simultaneously. Such simultaneous activity bears a risk that not all of the required transactions can be executed within the context of recent market prices and/or within proposed limits. This risk is called execution risk.

A well-known example is the financial futures market, where the price of the financial futures (e.g. T-note future) is closely linked to the price of the underlying (e.g. T-note) and vice versa. A market maker specialized in T-note futures can offset the risk resulting from buying or selling T-note futures by selling or buying T-notes in the spot market. Economically, these transactions are based on the so-called arbitrage mechanism which provides the link between these two markets. Although from an economic point of view the two markets are closely linked in respect to price and liquidity levels, and theoretically can neither move with different speed in the same direction nor separately in different directions, in reality this linkage is not as close as predicted by the related arbitrage model.

Therefore certain execution risks always remain with a market maker. In order to cope with this risk, the bid-ask-spread of the quotation that forms the basis for the reimbursement of the market maker is accordingly wide. Additionally, the quote for the product depends on the possibility to be able to buy or sell a related product from or in a different market in sufficient quantity.

In order to eliminate the risk, the market maker is forced to trade simultaneously in different markets and different instruments. For the above example, this means that a market maker has to buy T-notes at the same time when to sell T-note futures.

It is a drawback of a conventional electronic trading system that a conventional electronic trading system is not capable of linking trading in different instruments and different markets such as to guarantee the desired simultaneous trading.

Therefore, conventionally, the strategy of a market maker described above inherently includes the risk of being unbalanced. Either the market maker executes the one order from a market participant (called “initial order” below), but gets the hedge transaction executed at a worse price or the hedge transaction is executed but the initial order is no longer valid.

Therefore, in a conventional trading environment the market maker avoids or at least mitigates the execution risk by an increased bid-ask-spread (e.g. the quotation), which, on the other hand, causes higher costs for market participants. Moreover, in times when the markets are becoming fast, the quotation is either too wide to be attractive, or even worse, the market maker will stop quotation for a certain time.

### SUMMARY OF THE INVENTION

The present invention aims to provide an electronic trading system and a method for joint execution of an order of a market participant and a hedge transaction that protect the market maker from losses due to execution risk.

This is achieved by the features of the independent claims. Further objects and advantages of the present invention are set forth in dependent claims.

According to a first aspect of the present invention, a method of joint automatic execution of an initial order of a market participant for a financial product against the quote of a market maker and of a hedge transaction for protecting the market maker against the execution risk of the initial order is provided. The method comprises the step of matching the initial order of a market participant with the quote of the market maker. Moreover, the method comprises the step of generating an order for a hedge transaction corresponding to the initial order. Further, the method comprises the step of attempting to execute the hedge transaction. In a further step it is judged whether at least a part of the order for a hedge transaction has been executed. Finally, the method executes at least a part of the initial order corresponding to the executed part of the order for a hedge transaction.

According to a second aspect of the present invention, an electronic trading system, for executing an initial order of a market participant for a financial product against a quote of a market maker under the condition that a hedge transaction for protecting the market maker against the execution risk of the initial order has been successfully executed is provided. The system comprises a matching engine for matching the initial order of a market participant with a quote of the market maker. Further, the system comprises an order generator for generating an order for a hedge transaction corresponding to the initial order. Moreover, the system comprises a transmitter unit for transmitting the order for a hedge transaction to a trading system for execution of the hedge transaction. The system further comprises a judging unit for judging whether at least a part of the order for a hedge transaction has been executed. Furthermore, the electronic trading system comprises an execution unit for executing at least a part of the initial order corresponding to the executed part of the order for a hedge transaction.

It is the particular approach of the present invention to enable execution of an order of a market participant against the quote of a market maker only, if a corresponding hedge transaction has been successfully executed before. Therefore, an electronic trading system generates an order for a hedge transaction, if an initial order from a market participant has been matched against a quote of a market maker. The matched initial order will be executed only after acknowledgment of an execution of the hedge transaction, which preferably relates to a different market. Accordingly, it is avoided that the initial order is executed, but a corresponding hedge transaction can be executed only at a price that is worse than desired by the market maker.

Preferably, the initial order is an order for a derivative product. Derivative products such as options and futures are financial products that have their price related to or derived from an underlying product. However the proposed system and method of the invention are not limited to derivatives products.

Preferably, after matching an initial order from a market participant with a quote of a market maker, the initial order is set into a so-called freezed state for a predetermined time interval. In the freezed state the initial order is blocked from modifications or deletion. Accordingly, it is guaranteed that the initial order remains unamended during the predetermined time interval, wherein a corresponding hedge order can be generated and successfully executed. Hence, the situation is avoided, wherein the hedge transaction is executed, but the initial order is no longer valid, and the market maker is protected against the corresponding execution risk.

More preferably, the electronic trading system according to the present invention comprises a buffer for storing orders for modifying or deleting the initial order received during the predetermined time interval. Accordingly, the market participant who has placed the initial order into an order book can submit orders for modifying or deleting the initial order at any point of time. Although such orders are disabled for execution during the time interval wherein the initial order is in a freezed state, the modifying or deleting orders will not get lost. They will be retained in the buffer until the freezing time interval has elapsed. If a part of the initial order is still available after the freezing interval, i.e. no complete execution has been possible, the respective modification and deletion orders can be executed.

According to a preferred embodiment, if a hedge transaction has not been completely executed after expiry of the predetermined time interval for setting the initial order into the freezed state, the remaining non executed part of the hedge order is deleted. Accordingly, the system is free to start new matching processing with the corresponding remaining part of the initial order.

Preferably, the electronic trading system according to the present invention is also capable of internally matching an initial order with orders received from other market participants and executing the matching orders from a plurality of market participants against each other if they are successfully matched. Accordingly, matching against the quote of the market maker is necessary if no internal matching among the orders received from market participants is possible.

More preferably, the buffer is capable of storing, besides orders for modifying or deleting the initial order, also such orders that relate to the same financial product as the initial order that are received during the freezing time interval and that match with at least a part of the freezed initial order. Accordingly, after expiry of the freezing time interval internal matching and execution are possible, if no complete execution of the initial order against the market maker's quote has been performed.

More preferably, upon storing an order in the buffer a time stamp is generated. The time stamp enables establishing time priority, if a plurality of orders is received during the freezing period. After expiry of the freezing period without complete execution of the initial order, the order stored in the buffer having the earliest time stamp will be prioritized for execution.

More preferably, the electronic trading system is also capable of appropriately handling those new orders from market participants, of which only a part of the volume matches with the initial order. In such a case, an order received during the freezing time interval is split into a first part matching with the initial order and a second remaining part, and the buffer stores only the first part as an order matching with the initial order. Consequently, chances to get the initial order executed as soon as possible are enhanced.

Preferably, the predetermined time interval for setting the initial order into the freezed state is automatically extended by a further predetermined time interval, if no order is stored in the buffer after the predetermined time interval has elapsed without complete execution of the initial order. As in this case, the overall situation has remained unchanged during the freezing interval, further attempts to execute the corresponding hedge order, and the initial order are rendered possible without repeating the matching and hedge order generating steps.

Preferably, the initial order and the order for a hedge transaction relate to different markets.

Further embodiments of the present invention are the subject matter of dependent claims.

### BRIEF DESCRIPTION OF THE DRAWINGS

In the accompanying drawings, preferred embodiments of the invention are described in more detail. The drawings are not to be construed as limiting the present invention to only the illustrated and described examples of how the invention can be made and used. Further features and advantages will become apparent from the following and more particular description of the present invention, as illustrated in the accompanying drawings, wherein.

FIG. 1 illustrates an environment for an on-exchange or off-exchange trading system that may be used to implement aspects of the present invention.

FIG. 2 is a block diagram illustrating the structure of an electronic trading system according to the present invention with its main components and the involved entities according to an embodiment of the invention.

FIG. 3 illustrates the general flow of actions for the performance of linked securities transactions, in accordance with an embodiment of the invention.

FIG. 4 is a more detailed presentation of the flow for the activities to manage linkage between the two related orders, in accordance with an embodiment of the invention.

FIG. 5 is a flowchart illustrating the processing of new orders received during the time interval wherein the initial order is in a freezed state according to an embodiment of the present invention.

FIG. 6 is a detailed presentation of the flow for a timeout processing, in accordance with an embodiment of the invention.

### DETAILED DESCRIPTION OF THE INVENTION

The different aspects of the present invention will be described in the following with reference to the accompanying figure drawings, wherein like elements and structures are designated by like reference numerals.

In accordance with the present invention, an efficient infrastructure and secure process is provided for both market participants and market makers that improve speed and accuracy of order execution, while minimizing the execution risk for the market maker. The present invention is particularly applicable for executing two linked trades (for an initial order and for a corresponding hedge order) in different markets, usually handled by different trading systems.

The infrastructure connects the involved parties (market maker, market participants) and enables access to different markets in order to execute at least two related orders in a non-or-all quality and the provision of automatic quotations by the market maker. This means that the present invention ensures that either all of the concerned transactions or none of them are executed.

During the entire trading phase, the market maker continually supplies price spreads by entering quotes into a quote book. The market participant inserts orders into an order book. An order is potentially executable, if it matches with a quote. According to a preferred embodiment, a matched order will first be freezed to avoid modification or deletion by the market participant until a corresponding hedge transaction has been executed.

All other orders in the order book are still available for processing. Furthermore, new orders can be entered continuously in the order book. Only if a new order is directly related to a freezed order, this means request for modification or deletion of the freezed orders, as well as new orders matching with the freezed orders only in case of a non-pure market maker model, these ones are stored separately in a buffer.

The processing described above is related to a continuous trading model rather than an auction based trading model. Nevertheless, the present invention can be employed for an auction based trading model as well. However, the further description is based on the continuous trading model, as the auction based trading model can be seen as a special occurrence of the continuous trading model.

Based on reference data maintained by the market maker, preferably, the order generator included in the electronic trading system of the present invention automatically generates the corresponding hedge order for an initial order of a market participant, if desired. Alternatively, the market maker decides about the appropriate activities in his own responsibility.

The system sends the generated order to the predefined market. In case of the successful execution of the hedge order, the initial order is executed as well. If the hedge order cannot be executed in time, the hedge order will be cancelled. The initial order is not executed, but released and remains in the order book for further processing.

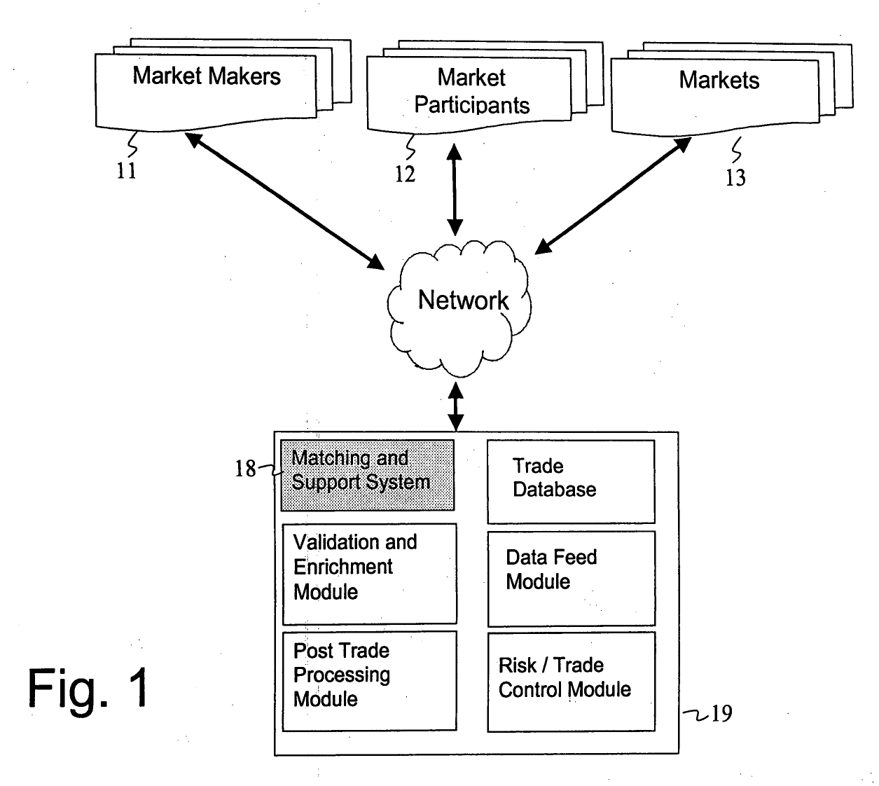

The present invention is implemented in a computer-based trading environment regardless whether that is an on-exchange or off-exchange trading system. A block scheme generally illustrating an example of such a trading system is given in FIG. 1.

The electronic trading system 19 is connected to a plurality of involved entities, such as market makers 11, market participants 12 and markets 13 via network. The network can be any existing or forthcoming network, such as LAN, a company's intranet, the internet, SWIFT or private communication lines, without being limited to the examples given above. The core of the electronic trading system according to the present invention is a matching and support system, designated by reference numeral 18 in FIG. 1.

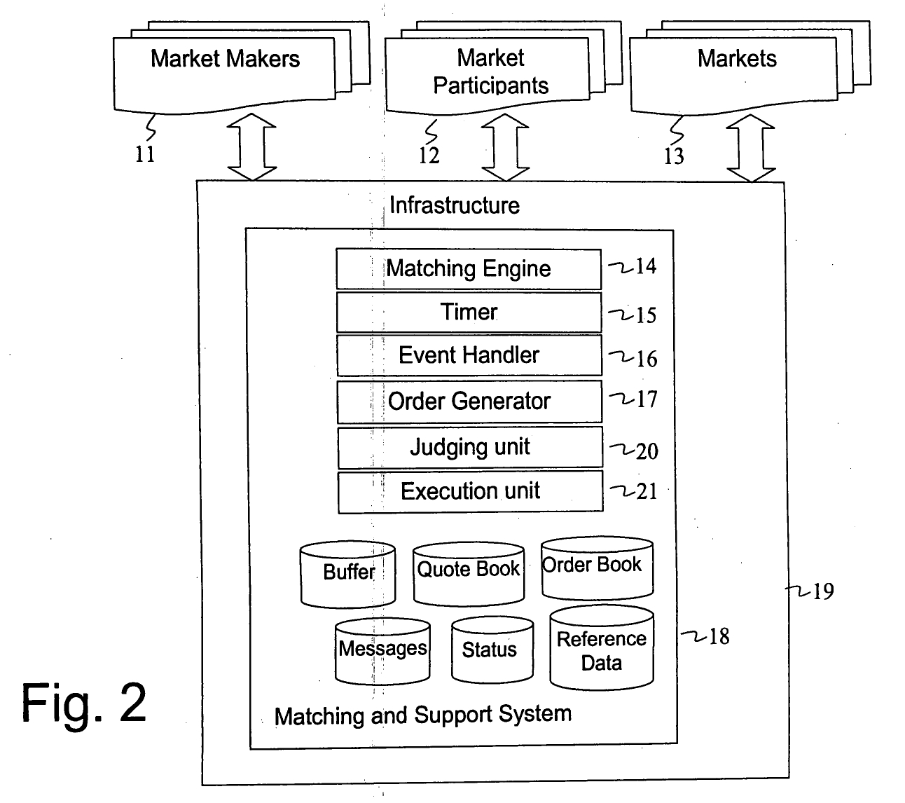

The matching and support system 18 is illustrated in more detail in FIG. 2. The system provides market makers 11, and market participants 12 with a secure and efficient transaction execution environment for linked transactions in different markets 13.

The matching and support system 18 comprises a matching engine 14, a timer 15, an event handler 16, an order generator 17, a judging unit 20, an execution unit 21 and several databases for storing required data.

Although not explicitly shown, the involved parties, such as market participants 12, market maker 11, and markets 13 have an input as well as an output unit for inputting respectively outputting transaction related information, and a transceiver unit for transmitting information to and from the matching and support system 18 via the network. Especially for market makers these units can comprise quote machines and program trading modules.

The matching and support system 18 continuously receives orders, limit as well as market orders, sent by a market participant 12.

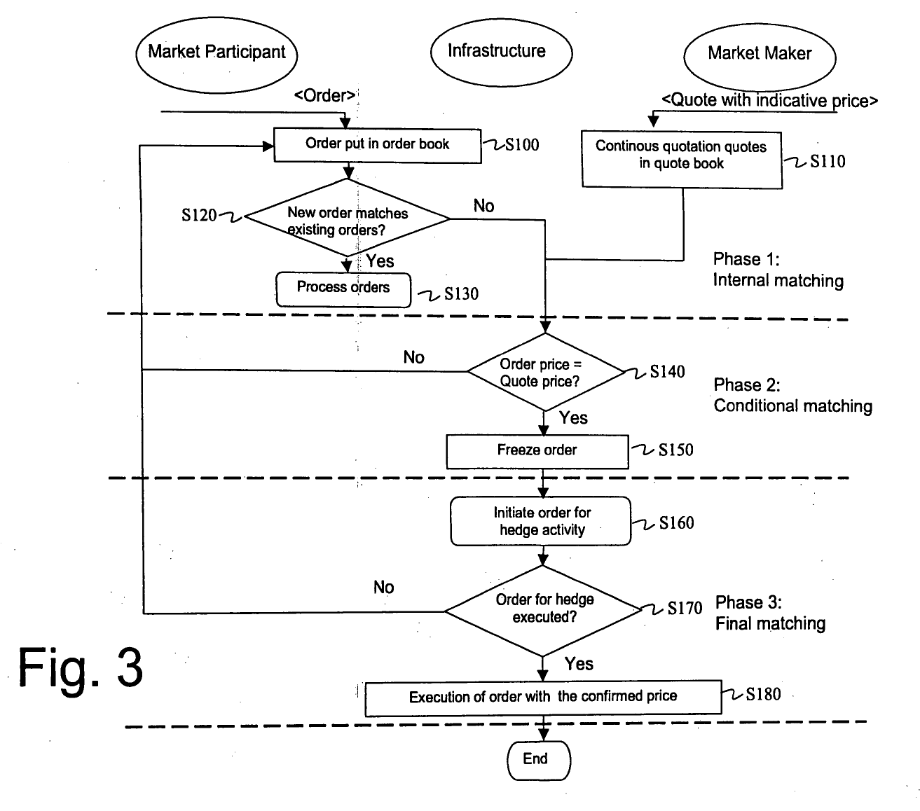

The general processing performed by a matching and support system 18 in accordance with the present invention will now be described with reference to FIG. 3.

If a received order passes an initial validation process successfully, it is stored in an order book (step S100).

On the other hand, the market maker 11 provides quotes, either on request or continuously, with an indicative price. These quotes are stored in a quote book (S110). A continuous provision of quotes is usually done automatically using suitable quote machines. Although in general such quote machines can be part of the infrastructure, this is not in the focus of the present invention.

As can be seen from FIG. 3, the general execution process performed by an electronic trading system in accordance with the present invention covers up to three phases. The number of the phases depends on the organization of the concerned market.

According to an embodiment of the invention, the processing starts with a so-called internal matching phase. In the internal matching phase, the system checks whether a new order matches with one or several existing orders (S120). In this case, the matching orders can be executed immediately without the involvement of the market maker (S130).

The processing of the internal matching phase in which orders from market participants will be matched against each other is only performed, if the concerned market is not organized as a pure market maker market. To the contrary, in a pure market maker market, there are only matches between orders from market participants against quotes from market makers. Therefore, in a pure market maker market there are only the conditional matching phase and the final matching phase as illustrated in FIG. 3, and as described in more detail below.

In the conditional matching phase the orders in the order book are continuously compared with the quotes in the quote book (S140). If a quote matches one or several orders in the order book, these orders get the status “freezed” for a predetermined time period in order to indicate that they are potentially executable (S150). Otherwise, the orders remain in the order book with the status “available”. For the remaining description only a single order rather than several orders is considered for sake of simplicity.

Orders in the order book can be deleted and modified as requested by the market participant in case the deletion and modification requests are valid. An order which is marked as freezed is not available for deletion or modification by market participants during the predetermined freeze period. However, valid deletion and modification requests will be stored in a buffer for further processing. Already existing orders, which are not in the status “freezed” can be modified or cancelled at any time by the market participant.

During the processing of the freezed order, the order book remains open, which means that new orders can be added continuously to the order book. If the quotes of the market maker compete with the orders of market participants (non-pure market maker market), a new order is regarded to be related to the freezed order, if it would match with the freezed order.

In the final matching phase, the hedge activities corresponding to the matching initial order are preferably performed automatically. Accordingly, the final matching phase starts with the automatic initiation of a corresponding hedge transaction step S160. If this hedge transaction can be executed successfully, (S170: Yes), freezed orders are finally executed at step S180. The indicative price of the quote becomes then the confirmed price.

Alternatively, the market maker can process the appropriate activities regarding the corresponding hedge transaction by his own. He then confirms execution of the corresponding hedge transaction, which will lead to the execution of the initial order with the confirmed price. If the market maker does not confirm, the initial order cannot be executed. This also implies that the corresponding quote is no longer valid.

If the corresponding hedge transaction failed within the freeze period (S170: No) then there is no final matching. The freezed order is released, that means that the status changes from “freezed” to “released”. Before this order is put in the order book with the status “available”, it will be checked whether there is any deletion or modification for this order in the buffer, and if yes, the order is deleted or changed accordingly. The changed order gets the status “available” and is put in the order book for further processing (see the arrow from S170: No to S100).

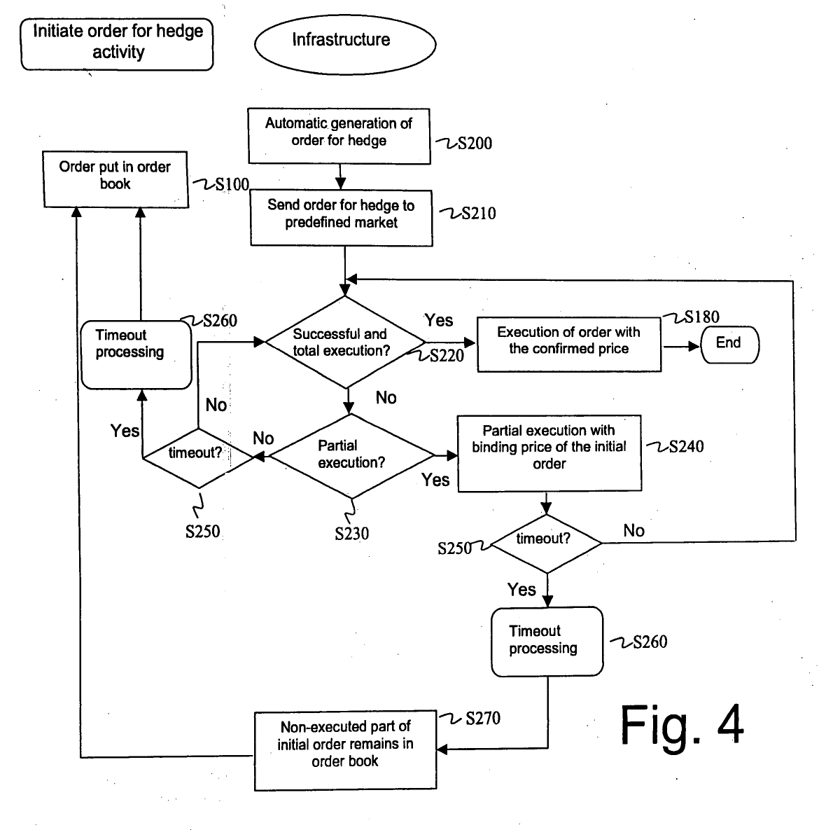

FIG. 4 illustrates the initiation of the hedge transaction in more detail. First, an order for the hedge transaction is automatically generated by the order generator 17 in step S200.

The order generator 17 disposes reference data defined by the market maker 11 for the required properties of the hedge order. This reference data comprehends data such as the security and the market 13 for execution, price and quantity. The definition of the reference data is usually based on a program-trading module. Such a module can either be provided within the infrastructure 19 or is part of the market maker's trading environment 11. The generated hedge order is sent to the predefined market 13 (S210), which usually is a different market operated by a different trading system. If during a predefined time period the hedge order is executed successfully (S220: Yes), the freezed order is finally executed as well (S180) and the linked transaction is completed successfully. The indicative price of the quote becomes then the confirmed price.

If during the predefined time period the hedge order can only be executed partially (S230: Yes), the corresponding part of the freezed order is also executed at step S240 with the indicative price becoming the confirmed price. As long as there is no timeout (S250: No), the remaining part of the hedge order is still valid and available for complete execution. When there is a timeout (S250: Yes), the further processing depends on whether there is a pure market maker market or in addition internal matching is supported.

In case of a pure market maker market, a timeout implies that a cancellation for the hedge order or a cancellation for the non executed part of the hedge order is sent to the market. After confirmation of the cancellation, the initial order respectively the remaining part of the initial order is released at step S270. Then it is checked whether there are any deletion or modification requests for this order in the buffer and if yes, the order is either deleted or changed accordingly, before the changed order will remain in the order book for further processing (indicated by the arrow from step S270 to step S100).

The duration of the freeze period is monitored by a timer. In the most straightforward way, the freeze period is a fixed predefined time period which can be determined individually for each security if desired. After expiry of the freeze period, the hedge order has to be cancelled. The confirmation of the cancellation leads to the release of the initial order.

If market prices have not changed, and there is no deletion or modification request for the initial order stored in the buffer, then the process with the internal matching phase starts again immediately. However, this implies that the hedge order with the same properties like the cancelled one is generated again. As long as the situation does not change, hedge order generation and hedge order cancellation are sent to and fro due to the fixed predefined freeze period.

In order to overcome this inefficiency, an alternative embodiment uses a more sophisticated approach. Instead of only considering a fixed time period for triggering a cancellation, additional relevant events are taken into account. These relevant events are requests for modification of price or quantity of the initial order or its deletion by the market participant. In case the freeze period has elapsed and there are no such events, the freeze period is extended. Such an extension can be repeated until there is a successful and complete execution of the hedge transaction and therefore also the successful and complete execution of the initial order or there have arrived modification or deletion requests.

If the freeze period has elapsed and additionally there is any modification or deletion request in the buffer for the initial order, the hedge order is modified or cancelled accordingly. The initial order is then either deleted, in case of a deletion request, or modified if requested.

In a pure market maker market, the orders continuously stored in the order book are instantaneously processed according to the above described process covering the conditional and final matching phase, which means that several orders which match with the quote can be processed in parallel.

If there is a competition between market maker and market participants, the internal matching phase becomes relevant as well for the timeout processing of step S260. The timeout processing (S260) has to consider new orders for internal matching even for already freezed orders. This implies that there are more events to be considered and the handling of events stored in the buffer becomes more complex.

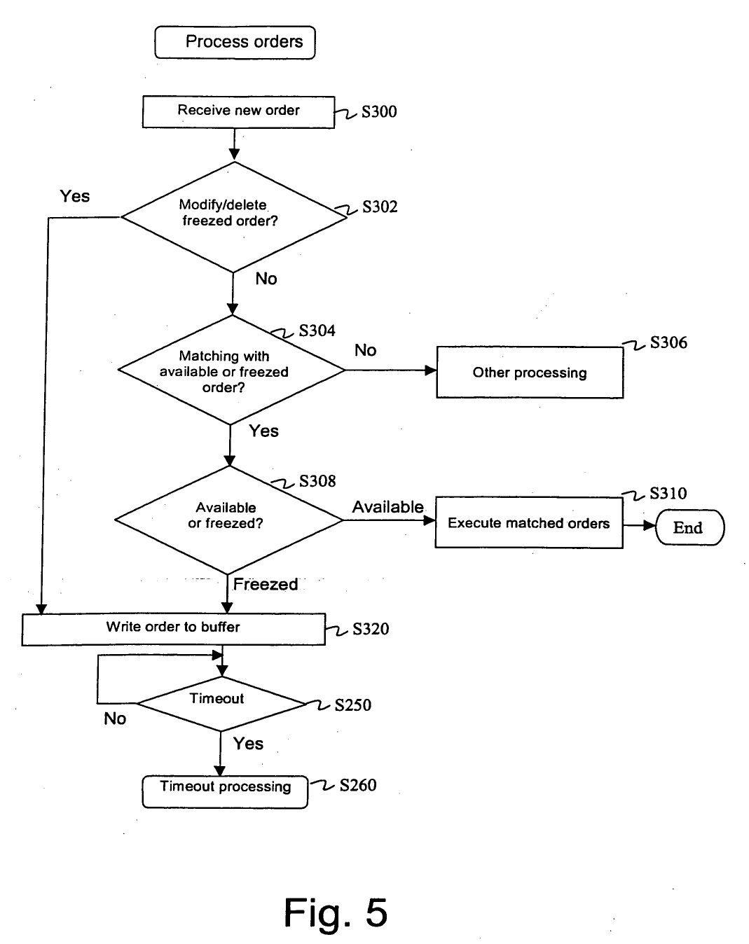

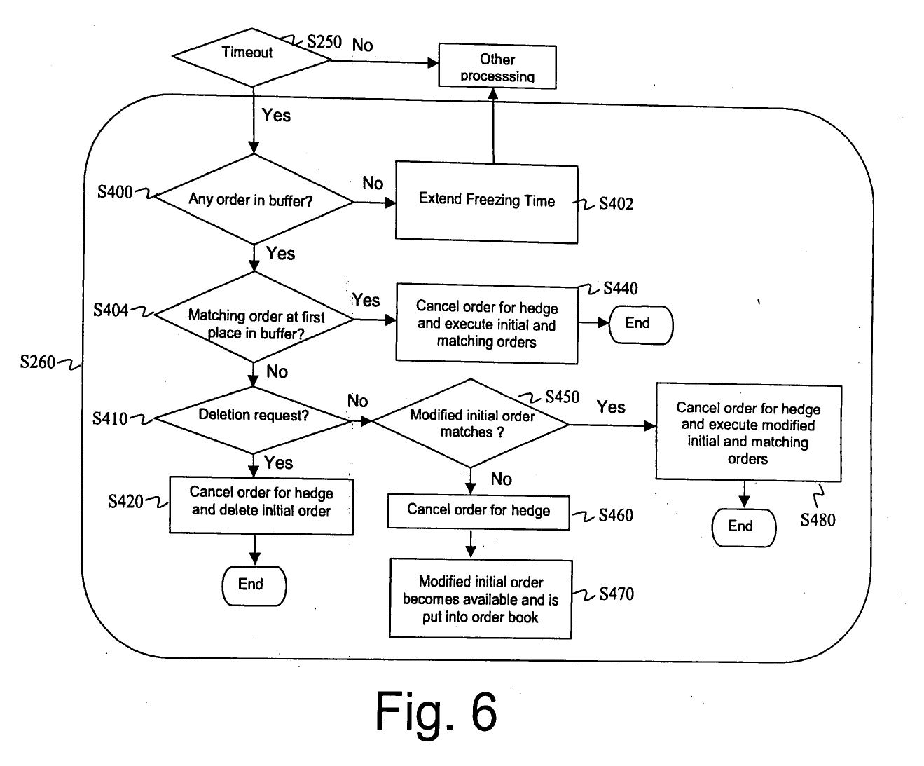

A possible solution for the general processing of received new orders is illustrated in FIG. 5. FIG. 6 illustrates the details of the timeout processing step S260.

As can be seen from FIG. 5, if a new order is received during the freeze time period (S300), at the first subsequent step S302 is judged, whether a new order is an order for modifying or deleting the freezed order. If the judgment result is “Yes”, the processing flow succeeds to step S320, wherein the new order is written to the buffer. Otherwise, the processing flow branches to step S304 (S302: No→S304). Step S304 judges, whether the new order is an order matching with an existing order, either available or freezed. In case of a negative judgment, other processing is performed at step S306. In case of an affirmative judgment, the subsequent step S308 judges whether the order matches with an available or a freezed order. If the new order matches with an order available in the order book, the respective matched orders are executed at step S310 and the processing ends. If the new order matches with a freezed order, the flow succeeds to step S320, wherein the new order is written to the buffer.

Preferably, any new order written to the order buffer will be stored in the buffer together with a time stamp at step S320. In case of a timeout (S250: Yes), the handling of the buffer has to consider orders matching with the freezed order as an additional event, if the initial order has not yet been completely executed.

The details of the timeout processing in accordance with the described embodiment of the present invention are illustrated in FIG. 6. Upon timeout, the system first checks whether there is any order in the buffer. If not (S400: No) the freezing time is extended (S402) as described above, and the processing returns to the position, whereat the timeout occurred.

If there is any order in the buffer (S400: Yes), step S404 judges, whether there is a matching order at the first place in the buffer (i.e. with the earliest time stamp). If there is an order matching with the freezed order in the buffer's first place, then the hedge order is cancelled and the internal matching between initial order and matching order from the buffer takes place at step S440.

Otherwise, there is either a deletion or modification request with a higher time priority. In case of a deletion request (S410: Yes), the hedge order is cancelled and the initial order is deleted as requested at step S420. If the buffer furthermore contains any order that would have matched with the freezed order (which is now deleted), the matching order will become available and is put into the order book.

If a modification for the freezed order is requested (S410: No), further processing depends upon whether the modified initial order matches with any other order that is available in the order book, or that is stored in the buffer with a later time stamp. If no internal matching is possible (S450: No), at subsequent step S460 the hedge order is cancelled, and the modified initial order becomes available and is put into the order book (S470). Otherwise (S450: Yes) the hedge order is cancelled, and the modified initial order is executed against a matching order (S480).

For simplicity, the foregoing detailed description of the timeout processing has been given for the case, wherein no partial execution of the initial order has been performed, such that the complete initial and hedge orders are still available (S230: No). However, the described timeout processing also applies to the case, wherein only a non-executed part of the initial order and of the hedge order remain available after partial execution (S230: Yes, S240). Accordingly, the timeout processing will consider, whether to delete or modify the remaining part of the initial order, or internally match the remaining part of the initial order, depending on the time priority of the orders in the buffer.

As there is possible continuous input for market participants, such input can also include deletion or modification requests for orders related to the initial order, i.e. orders which are stored in the buffer that match with the freezed initial order. The buffer is based on time priority. If there are deletion or modification requests for a related order, then such a request will be processed on the related order. Based on the request different results are possible. First, the related order will be deleted from the buffer completely in case of a deletion request. Second, in case of a modification request, the related order will be removed from the buffer and modified accordingly. If it is still a related order, it goes to the buffer again, but with a new time stamp and therefore priority. Otherwise, if it is no longer a related order, it will be put into the order book for further processing.

Additionally, if the quantity of a related order exceeds the quantity of a freezed order, the related order can be internally split in two parts based on the quantity of the freezed order. The first part covers the quantity identical to the quantity of the freezed order. This one is written into the buffer as a related order. The second part which represents the surplus in quantity is written into the order book and will be processed accordingly. This split up causes more complexity and has to be managed accordingly in case of modifications and deletion of this order.

While the present invention has been particularly illustrated and described with reference to the preferred embodiments, it will be understood that various changes and modifications will occur to those skilled in the art without departing from the scope and true spirit of the invention. The scope of the invention is therefore to be determined solely by the appended claims.

In summary, the present invention relates to an electronic trading system and a method for automatically performing an execution of an order from a market participant against a quote of a market maker. According to the present invention, an order from a market participant is executed against the matching quote of a market maker only, if a corresponding hedge transaction for mitigating the market maker's execution risk has been generated and successfully executed. Thereby the initial order and the hedge transaction preferably relate to different markets, such that the invention provides a conditional link between trades performed in these markets.

What is claimed is:

1. A method of joint automatic execution of an initial order of a market participant for a financial product against a quote of a market maker and of a hedge transaction for protecting the market maker against the execution risk of the initial order, the method comprising the steps of:
matching the initial order of a market participant with a quote of the market maker,
generating an order for a hedge transaction corresponding to said initial order,
attempting to execute said hedge transaction,
judging whether at least a part of said order for a hedge transaction has been executed, and
executing at least a part of the initial order corresponding to the executed part of the order for a hedge transaction.

2. The method of claim 1, further comprising the step of setting the initial order into a freezed state for a predetermined time interval, after matching the initial order with a quote of the market maker, said freezed state blocking the initial order from modifications or deletion.

3. The method of claim 2, further comprising the step of storing orders for modifying or deleting said initial order received during said predetermined time interval in a buffer.

4. The method of claim 3, further comprising the step of checking whether or not said buffer storing an order for modifying or deleting said initial order after expiry of said predetermined time interval, if the initial order has not been completely executed.

5. The method of claim 4, further comprising the step of modifying or deleting a non-executed remaining part of said initial order in accordance with an order for modifying or deleting stored in said buffer after expiry of said predetermined time interval.

6. The method of claim 2, further comprising the step of deleting a part of said order for a hedge transaction that has not been executed after expiry of said predetermined time interval.

7. The method of claim 4, further comprising the step of extending said predetermined time interval by a further predetermined time interval, if no order for modifying or deleting said initial order is stored in said buffer and the initial order has not been completely executed after expiry of said predetermined time interval setting said initial order into said freezed state.

8. The method of claim 2, further comprising the step of receiving at least a new order from a market participant matching with at least a part of said freezed initial order or an order for modifying/deleting said freezed initial order during said predetermined time interval.

9. The method of claim 8, further comprising the steps of
generating a time stamp for each of said orders received during said predetermined time interval, and
storing said orders received during said predetermined time interval in a buffer arranged in accordance with said time stamp.

10. The method of claim 9, further comprising the step of judging whether the order in said buffer having the earliest time stamp is an order matching with at least a part of said initial order or an order for modifying said initial order or an order for deleting said initial order.

11. The method of claim 10, further comprising, if the initial order has not been completely executed after expiry of said predetermined time interval, the steps of:
deleting the non-executed part of said order for a hedge transaction, if the order with the earliest time stamp stored in said buffer is an order matching with the remaining part of with said initial order, and
executing the remaining part of said initial order against said order stored in the buffer matching with the remaining part of said initial order.

12. The method of claim 10, further comprising, if the initial order has not been completely executed after expiry of said predetermined time interval, the step of deleting the non-executed remaining part of said order for a hedge transaction and said initial order, if the order with the earliest time stamp stored in said buffer is an order for deleting said initial order.

13. The method of claim 10, further comprising, if the initial order has not been completely executed after expiry of said predetermined time interval, the steps of
modifying the non-executed remaining part of said initial order, if the order with the earliest time stamp stored in said buffer is an order for modifying said initial order,
judging whether there is an order stored in said buffer matching with the modified part of the initial order,
deleting the non-executed remaining part of said order for a hedge transaction if there is an order matching with said modified part of the initial order, and
executing said modified part of the initial order against said matching order.

14. The method of claim 9, further comprising the step of extending said predetermined time interval by a further predetermined time interval, if no order is stored in said buffer and the initial order has not been completely executed after expiry of said predetermined time interval setting said initial order into said freezed state.

15. The method of claim 1, wherein said initial order and said order for a hedge transaction relate to different markets.

16. An electronic trading system for executing an initial order of a market participant for a financial product against a quote of a market maker under the condition that a hedge transaction for protecting the market maker against the execution risk of the initial order has been successfully executed, comprising:
a matching engine for matching the initial order of a market participant with a quote of the market maker,
an order generator for generating an order for a hedge transaction corresponding to said initial order,
a transmitter unit for transmitting said order for a hedge transaction to a trading system for execution of said hedge transaction,
a judging unit for judging whether at least a part of said order for a hedge transaction has been executed, and
an execution unit for executing at least a part of the initial order corresponding to the executed part of the order for a hedge transaction.

17. The system of claim 16, further setting the initial order after being matched with a quote of the market maker in a freezed state, said freezed state blocking the initial order from modifications or deletion, the system further comprising
a timer for monitoring a predetermined time interval, during which the initial order is set into said freezed state.

18. The system of claim 17, further comprising a buffer for storing orders for modifying or deleting said initial order received during said predetermined time interval.

19. The system of claim 18, further comprising an event handler for checking whether or not said buffer storing an order for modifying or deleting said initial order after expiry of said predetermined time interval.

20. The system of claim 19, further comprising an order book modifying unit for modifying or deleting a non-executed remaining part of said initial order in accordance with an order for modifying or deleting stored in said buffer after expiry of said predetermined time interval.

21. The system of claim 17, further comprising a hedge order deleting unit for deleting at least a part of said order for a hedge transaction that has not been executed after expiry of said predetermined time interval.

22. The system of claim 19, wherein said timer being capable of extending said predetermined time interval by a further predetermined time interval, if no order for modifying or deleting said initial order is stored in said buffer and the initial order has not been completely executed after expiry of said predetermined time interval setting said initial order into said freezed state.

23. The system of claim 18, wherein
said matching engine further being capable of matching said initial order with orders from other market participants, and
said execution unit further being capable of executing said initial order against one or a plurality of matching orders from other market participants.

24. The system of claim 23, wherein said buffer further being capable of storing orders received during said predetermined time interval matching with said freezed initial order.

25. The system of claim 24, further comprising a time stamp generating unit for generating a time stamp for each of said orders received during said predetermined time interval, wherein said buffer being capable of arranging the stored orders in accordance with said time stamp.

26. The system of claim 25, further comprising an event handler for judging whether the order in said buffer having the earliest time stamp is an order matching with a least a part of said initial order or an order for modifying said initial order or an order for deleting said initial order.

27. The system of claim 26, further comprising a hedge order deleting unit for deleting a non-executed remaining part of said order for a hedge transaction after expiry of said predetermined time interval, if the initial order has not been completely executed and the order with the earliest time stamp stored in said buffer is an order matching with the remaining part of said initial order.

28. The system of claim 26, further comprising
a hedge order deleting unit for deleting a non-executed remaining part of said order for a hedge transaction, after expiry of said predetermined time interval, if the order with the earliest time stamp stored in said buffer is an order for deleting said initial order, and
an order book modifying unit for deleting a non-executed remaining part of said initial order, after expiry of said predetermined time interval, if the order with the earliest time stamp stored in said buffer is an order for deleting said initial order.

29. The system of claim 26, further comprising,
an order book modifying unit for modifying a non-executed part of said initial order, after expiry of said predetermined time interval, if the initial order has not been completely executed and the order with the earliest time stamp stored in said buffer is an order for modifying said initial order, wherein said event handler further being capable of judging whether there is an order stored in said buffer matching with the modified part of the initial order, and
a hedge order deleting unit for deleting the non-executed remaining part of said order for a hedge transaction if there is an order matching with said modified part of the initial order.

30. The system of claim 23, wherein said system further receiving a new order from a market participant that relates to the same financial product as said initial order during said predetermined time period for setting said initial order into said freezed state,
said matching engine further being capable of determining whether a part of the volume of said received new order matches with said initial order, the system further comprising
a splitting unit for splitting said received new order into a first part matching with said initial order and a second part, wherein
said buffer being capable of storing said first part as an order matching with said initial order.

31. The system of claim 23, wherein said timer being capable of extending said predetermined time interval by a further predetermined time interval, if no order is stored in said buffer and the initial order has not been completely executed after expiry of said predetermined time interval setting said initial order into said freezed state.

32. The system of claim 16, wherein
said matching engine further being capable of matching said initial order with orders from other market participants, and
said execution unit further being capable of executing said initial order against one or a plurality of matching orders from other market participants.

33. The system of claim 16, wherein said trading system for executing said hedge transaction relates to a different market than the market of said initial order.
